(19) United States
(12) Patent Application Publication
(10) Pub. No.: US 2024/0394761 A1
(43) Pub. Date: Nov. 28, 2024

(54) Gemstone Inventory Tracking, Management, and Sales Systems and Methods

(71) Applicant: Digital Mining, LLC, Asheville, NC (US)

(72) Inventor: Elliott Spicer, Asheville, NC (US)

(73) Assignee: Digital Mining, LLC, Asheville, NC (US)

(21) Appl. No.: 18/781,339

(22) Filed: Jul. 23, 2024

Related U.S. Application Data
(63) Continuation-in-part of application No. 18/070,632, filed on Nov. 29, 2022.
(60) Provisional application No. 63/286,141, filed on Dec. 6, 2021.

(51) Int. Cl. G06Q 30/0283; G06Q 30/02; G06Q 40/04

(52) U.S. Cl. CPC G06Q 30/0283; G06Q 30/0278; G06Q 40/04

(57) ABSTRACT

A gemstone appraisal system. The system may include a server accessible via a network, the server including a pricing application, a pricing algorithm, a pricing GUI, controller, operating memory, and a communications interface. The system may further include a data store in communication with the server; and one or more data sources, accessible to the pricing application via the network. The controller may be configured to execute stored program instructions, including providing access to a user; receiving gemstone data related to a subject gemstone; querying one or more data sources for pricing information of gemstones having the same characteristics as the subject gemstone; analyzing the query results and calculating in real-time pricing data for the subject gemstone, the pricing data may include historical, dealer, and/or retail price data, and/or a buy price for the subject gemstone; and generating a price report for the subject gemstone.

### CROSS REFERENCE TO RELATED APPLICATIONS

This application is a continuation-in-part of U.S. patent application Ser. No. 18/070,632, filed Nov. 29, 2022, the application of which claims priority to U.S. Provisional Application No. 63/286,141, filed Dec. 6, 2021, the entire disclosures of which are incorporated herein by reference.

### TECHNICAL FIELD

The presently disclosed subject matter relates generally to a gemstone inventory management system and more particularly to gemstone inventory tracking, management, and sales systems and methods.

### BACKGROUND

Traditionally, the gemstone industry, and in particular the diamond industry, has always been a very secretive industry with little transparency for the end consumers. When buying a gemstone, e.g., a diamond, end consumers are forced to “trust” the retailer they are buying from, that they are getting a fair deal. In the retail landscape for diamonds, for example, the markup can be as much as 400% to as little as 15% for the exact same diamond, and the end consumer has no way of knowing the percent markup being applied.

Also, there is currently no real effective way to manage a retailer's gemstone inventory to ensure that the retailer is not over stocking or under stocking their inventory.

Further, there is not an effective systematic way to show/display gemstones to a customer in an organized and strategic way that allows, both the customer and the retailer, the ability to quickly and easily compare gemstones across various quality and size attributes.

Accordingly, there is a need for an improved transparency in the buying and selling of gemstones. There is also a need for an improved system and method of tracking and managing gemstone inventory in a retail environment. There is further a need for an improved system and method of show/display gemstones to a customer to improve the customer experience.

### SUMMARY

In one embodiment, a gemstone inventory management system is provided. The gemstone inventory management system may include a server, which may include a pricing application, a controller, operating memory, and a communications interface, and the server may be accessible via a network. The system may further include a data store in communication with the server; one or more data sources. The one or more data sources may be accessible to the pricing application via the network. The controller may be configured to execute stored program instructions, including providing access to a user; receiving gemstone data related to gemstones in an inventory of a gemstone retailer; receiving input selecting a particular gemstone of interest; querying an inventory of one or more data sources via the network for pricing information of gemstones having substantially the same characteristics as that of the gemstone of interest; analyzing the inventory query results and calculating a real-time average dealer price for the gemstone of interest; automatically calculating either or both of a retail price and a buy price for the gemstone of interest; and/or displaying the calculated average dealer price along with the calculated retail price and/or the calculated buy price for the gemstone of interest. One or more data sources may include one or more gemstone trading platforms comprising dealer/wholesale gemstone pricing information. The user may access the pricing application of the gemstone inventory management system through the network via a web browser using a computing device, or the user may access the pricing application of the gemstone inventory management system via a local pricing application installed on a computing device. The data store may include available gemstones in the inventory of the gemstone retailer. The gemstone data may include gemstone type and its associated characteristics. The associated characteristics may include size and quality attributes. The associated characteristics may include one or more of cut, color, clarity, carat, fluorescence, lab grade, and size. Calculating the average dealer price for the selected gemstone of interest may include averaging the real-time pricing information for all gemstones retrieved from the query of the inventory of the one or more data sources. Calculating the retail price for the selected gemstone of interest may include adding a specific percent markup to the calculated average dealer price. Calculating the buy price for the gemstone of interest may include subtracting a specific percent reduction from the calculated average dealer price. A calculated average dealer price and either or both of the calculated retail price and the calculated buy price may be displayed as historical chart or graph over a defined period of time. The controller may be configured to execute stored program instructions that may further include displaying the gemstone type and associated characteristics of the selected gemstone of interest. The selected gemstone of interest may include one of a gemstone in the inventory of the gemstone retailer or a gemstone of a third party seller looking to sell the gemstone to the gemstone retailer.

In another embodiment, a method of using a gemstone inventory management system is provided. The method may include, providing a gemstone inventory management system. The gemstone inventory management system may include a server, including a pricing application, a controller, operating memory, and a communications interface, and the server may be accessible via a network. The system may further include a data store in communication with the server; one or more data sources, wherein the one or more data sources may be accessible to the pricing application via the network; and wherein the controller may be configured to execute stored program instructions. The instructions may include providing access to a user; receiving gemstone data related to gemstones in an inventory of a gemstone retailer; receiving input selecting a particular gemstone of interest; querying an inventory of one or more data sources via the network for pricing information of gemstones having substantially the same characteristics as that of the selected gemstone of interest; analyzing the inventory query results and calculating in real-time an average dealer price for the selected gemstone of interest; automatically calculating either or both of a retail price and a buy price for the selected gemstone of interest; and displaying the calculated average dealer price along with either or both of the calculated retail price and the calculated buy price for the selected gemstone of interest. The method may further include, accessing the pricing application; selecting one or more gemstones of interest; calculating an average dealer price in real-time; calculating either or both of a retail price and a buy price for the selected one or more gemstones of interest; displaying the calculated average dealer price along with at least one of the calculated retail price and the calculated buy price for the one or more gemstones of interest. One or more data sources may include one or more gemstone trading platforms comprising dealer/wholesale gemstone pricing information. The user may access the pricing application of the gemstone inventory management system through the network via a web browser using a computing device, or the user may access the pricing application of the gemstone inventory management system via a local pricing application installed on a computing device. The data store may include available gemstones in the inventory of the gemstone retailer. The gemstone data may include gemstone type and its associated characteristics. The associated characteristics may include size and quality attributes. The associated characteristics may include one or more of cut, color, clarity, carat, fluorescence, lab grade, and size. Calculating the average dealer price for the selected gemstone of interest may include averaging the real-time pricing information for all gemstones retrieved from the query of the inventory of the one or more data sources. Calculating the retail price for the selected gemstone of interest may include adding a specific percent markup to the calculated average dealer price. Calculating the buy price for the gemstone of interest may include subtracting a specific percent reduction from the calculated average dealer price. A calculated average dealer price and either or both of the calculated retail price and the calculated buy price may be displayed as historical chart or graph over a defined period of time. The controller may be configured to execute stored program instructions that may further include displaying the gemstone type and associated characteristics of the selected gemstone of interest. The selected gemstone of interest may include one of a gemstone in the inventory of the gemstone retailer or a gemstone of a third party seller looking to sell the gemstone to the gemstone retailer.

In yet another embodiment, a gemstone appraisal system is provided. The gemstone appraisal system may include a server accessible via a network, the server including a pricing application, a pricing algorithm, a pricing GUI, controller, operating memory, and a communications interface. The gemstone appraisal system may further include a data store in communication with the server; and one or more data sources, accessible to the pricing application via the network. The controller may be configured to execute stored program instructions, including providing access to a user; receiving gemstone data related to a subject gemstone; querying one or more data sources for pricing information of gemstones having substantially the same characteristics as that of the subject gemstone; analyzing the query results and calculating in real-time pricing data for the subject gemstone, wherein the pricing data may include one or more of a historical price data, dealer/wholesale price data, retail price data, and/or a buy price for the subject gemstone; and generating a price report for the subject gemstone, the price report including the calculated pricing data. The system of claim 1 wherein the one or more data sources comprise one or more gemstone trading platforms comprising dealer/wholesale and/or retail gemstone pricing information. The user may access the pricing application of the gemstone appraisal system through the network via a web browser using a computing device. The user may access the pricing application of the gemstone appraisal system via a local pricing application installed on a computing device. The gemstone data may include gemstone type and associated characteristics of the subject gemstone. The pricing GUI may prompt the user to enter the gemstone data of the subject gemstone into the pricing application. The associated characteristics may include size and/or quality attribute data. The associated characteristics may include one or more of cut, color, clarity, carat, fluorescence, lab grade, and size. Calculating the pricing data of the subject gemstone may include averaging the real-time pricing information for all the gemstones having substantially the same characteristics retrieved from the query of the one or more data sources. The subject gemstone may include a customer gemstone.

In still yet another embodiment, a method of using a gemstone appraisal system is provided. The method may include providing a gemstone appraisal system. The gemstone appraisal system may include a server accessible via a network, the server including a pricing application, a pricing algorithm, a pricing GUI, controller, operating memory, and a communications interface. The gemstone appraisal system may further include a data store in communication with the server; and one or more data sources, accessible to the pricing application via the network. The controller may be configured to execute stored program instructions, including providing access to a user; receiving gemstone data related to a subject gemstone; querying one or more data sources for pricing information of gemstones having substantially the same characteristics as that of the subject gemstone; analyzing the query results and calculating in real-time pricing data for the subject gemstone, wherein the pricing data may include one or more of a historical price data, dealer/wholesale price data, retail price data, and/or a buy price for the subject gemstone; and generating a price report for the subject gemstone, the price report including the calculated pricing data. The method may further include accessing the pricing application; entering gemstone attribute data of the subject gemstone; processing the entered gemstone attribute data together with information from the one or more data sources; calculating real-time pricing data for the subject gemstone, wherein the pricing data may include one or more of a historical price data, dealer/wholesale price data, retail price data, and/or a buy price for the subject gemstone; and generating a price report for the subject gemstone, wherein the price report may include the calculated pricing data.

### BRIEF DESCRIPTION OF THE DRAWINGS

Having thus described the presently disclosed subject matter in general terms, reference will now be made to the accompanying drawings, which are not necessarily drawn to scale, and wherein:

FIG. 1 illustrates a block diagram of an example of a real-time gemstone dealer pricing system, in accordance with an embodiment of the invention;

FIG. 2 illustrates an example screenshot of the real-time gemstone dealer pricing system, in accordance with an example embodiment of the invention;

FIG. 3 illustrates another example screenshot of the real-time gemstone dealer pricing system, in accordance with an example embodiment of the invention;

FIGS. 4-7 illustrate examples of a smart grid display smart grid display system, in accordance with an embodiment of the invention;

FIG. 8 illustrates a slot of a smart grid display showing an example of a position/tracking code, in accordance with an embodiment of the invention;

FIG. 9 illustrates an example of a smart grid display with open slots, in accordance with an embodiment of the invention;

FIG. 10 illustrates an example screenshot from the smart grid display system showing a particular gemstone's information, in accordance with an embodiment of the invention;

FIGS. 11A and 11B illustrate screenshots of an example database including example types of information captured for a particular category of gemstone, in accordance with an embodiment of the invention;

FIG. 12 illustrates an example screenshot of a gemstone comparison tool showing a plurality of gemstone for comparison, in accordance with an embodiment of the invention;

FIG. 13 illustrates an example screenshot of the gemstone comparison tool of FIG. 12 with additional details reveled, in accordance with an embodiment of the invention;

FIG. 14 illustrates an example of a smart grid display indicating arrangement of gemstone therein relative to ct size and quality, in accordance with an embodiment of the invention;

FIG. 15 illustrates an example “gemstone bar,” in accordance with an embodiment of the invention;

FIG. 16 illustrates example screenshots of a customer gemstone appraisal system, in accordance with an embodiment of the invention; and

FIG. 17 illustrates a flow diagram of an example of a method of using the live customer gemstone appraisal system, in accordance with an embodiment of the invention.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the subject matter of the invention provides a gemstone inventory tracking, management, and sales system.

In some embodiments, the subject matter of the invention provides a real-time gemstone dealer pricing system and method.

In some embodiments, the subject matter of the invention provides a smart gemstone grid display system and method.

In some embodiments, the subject matter of the invention provides a gemstone comparison system and method.

For the sake of simplicity in describing the subject matter of the invention, the description below is describe mostly in terms of diamonds. However, diamonds are only one example of gemstone that the invention may apply to, therefor it is understood that subject matter of the invention may be applied to any type of gemstone(s).

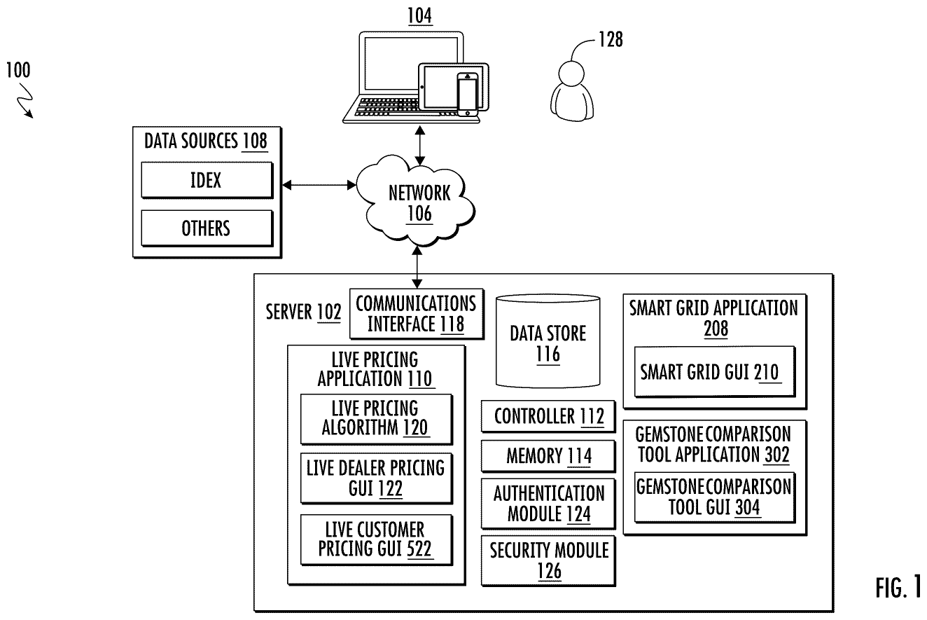

Referring now to FIG. 1 is a block diagram of an example of a gemstone inventory management system 100, in accordance with an embodiment of the invention. the inventory management system 100 may include, for example, a server 102, connected to one or more user computers 104 via a network 106, and one or more data sources 108.

Server 102 may further include a live gemstone pricing application 110, a controller 112 that may include a certain amount of operating memory 114, a data store 116, and a communications interface 118. Controller 112 may be any standard controller or microprocessor device that is capable of executing program instructions. Controller 112 may be used to manage the overall operations of the inventory management system 100. Memory 114 may be any volatile or non-volatile memory device. Memory 114 may be built into or separate from controller 112. Data store 108 may be, for example, data repositories (like databases) and/or flat files that can store data. In one example, data store 116 may be a Structured Query Language (SQL) database. Further, inventory management system 100 is not limited to one data store 108 only. The inventory management system 100 may include multiple data stores 108.

Server 102 may be, for example, an application server. Server 102 can be any networked computing configuration as long as it is accessible by user computer 104 that may be operated by one or more users 128, such as a gemstone retailer/dealer, and any of the data sources 108. For example, inventory management system 100, and more particularly live gemstone pricing application 110, may support a cloud computing environment. In a cloud computing environment, server 102 may be the cloud server. Further, live gemstone pricing application 110 is not limited to running on one server 102 only. Inventory management system 100 may include multiple servers 102 (or cloud servers) in order to ensure high-availability of computing resources.

At server 102, live gemstone pricing application 110 may further include one or more of a live gemstone pricing algorithm 120 and a live dealer pricing tool graphical user interface (GUI) 122. Server 102 may further include an authentication module 124 and a security module 126. Generally, live gemstone pricing application 110 at server 102 may be a software and/or hardware application. Additionally, server 102 may be accessible via a network 106. Network 106 may be, for example, a local area network (LAN) and/or a wide area network (WAN) for connecting to the Internet or to an Intranet. Server 102 may connect to network 106 by any wired and/or wireless means.

User computer 104 may be any computing device, such as, but not limited to, a desktop computer, a laptop computer, a handheld computing device, a mobile phone (or smart phone), a tablet device, a smartwatch, and/or the like.

Network 106 may be, for example, a local area network (LAN) and/or a wide area network (WAN) for connecting to the Internet or to an Intranet. Server 102 and user computer 104 may connect to network 106 by any wired and/or wireless means. For example, server 102 may connect to network 106 via communications interface 118.

Communications interface 118 may be any wired and/or wireless communication interface for connecting to a network (e.g., network 106) and by which information may be exchanged with other devices connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+ (Advanced Network Tools) technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols.

Data sources 108 may include any sources of information that may be useful to live gemstone pricing application 110, such as real-time dealer/wholesale trade values of gemstones, such as diamonds. Data sources 108 may include, for example, one or more online gemstone trading platforms, such as, but not limited to, the International Diamond Exchange (IDEX), Rapnet, Polygon, Virtual diamond Boutique, and/or the like.

The users 128 may access live gemstone pricing application 110 at server 102 via their respective user computers 104 and network 106.

In one example, users 128 may interact with the live gemstone pricing application 110 using live dealer pricing tool GUI 122 at server 102. In this example, live dealer pricing tool GUI 122 may be a web-based GUI that is accessible via network 106. For example, live gemstone pricing application 110 at server 102 may be a software application that may be implemented as a web application and run in a web browser, such as Google Chrome or Microsoft Edge.

A desktop application or mobile app may be installed and running on each of the user computers 104. Such a desktop application or mobile app may be implemented, for example, as a .NET application, a desktop application, a mobile app, an application program interface (API), and the like, and may be designed to operate on any device platform, including for example, Windows, Android, Apple, and the like. Accordingly, users 128 may interact with the live gemstone pricing application 110 using a desktop or mobile app of their user computer 104 (e.g., smart phone or tablet device).

In one example, authentication module 124 may be used to manage the authentication process of any entities of the inventory management system 100, such as users 128 (retailer/dealer). For example, when the user 128 access the inventory management system 100, a standard authentication process may be performed that allows the user 128 to access one of the applications running on the server 102, such as, live gemstone pricing application 110. User-sign in may occur a number of ways. In one example, the user 128 may use a web browser to access live dealer pricing tool GUI 122 of live gemstone pricing application 110 and enter credentials (e.g., username and password).

In one example, a security module 126 of the inventory management system 100 may be used to perform any system security functions with respect to keeping secure the contents of data store 116 and/or any other information with respect to the inventory management system 100. Security module 126 may use standard security techniques, such as encryption, secure hashtags (or hash tags), and the like.

In one example, live gemstone pricing algorithm 120 may be used to process information generated and/or received by live gemstone pricing application 110 and thereby manage operations of the inventory management system 100. In one example, live gemstone pricing algorithm 120 may be used to process a gemstone's, e.g., diamond's, dealer pricing information retrieved from one or more online gemstone trading platforms, such as, IDEX, and in real-time calculate an average live dealer price for a diamond having certain characteristics.

In one example, for a gemstone, e.g., such as a diamond, an average live dealer price may be calculated in real-time. The calculated average live dealer price is the current average wholesale price of a like diamond, i.e., a diamond of the same quality and size (e.g., cut, color, clarity, carat, fluorescence, lab grade). The average live dealer price, allows a customer to be aware, of the current average dealer cost (wholesale cost), as the market changes, of a retailer/dealer's diamonds, thus giving the customer full transparency of what a particular diamond of interest trades for on the wholesale trade platforms in real-time, i.e., that day (the average price the retailer/dealer would pay if the retailer/dealer were to buy the same diamond on one of the wholesale trade platforms).

Using the calculated average live dealer price, the retailer/dealer may set a retail price of, for example, a specific percent above the live dealer price (e.g., 20%), for which the customer may purchase the diamond. In another example, where a customer is looking to sell a diamond to the retailer/dealer, the retailer/dealer 120 may set a buy price, for example, a specific percent below the live dealer price (e.g., 20%), and offer to buy the diamond from the customer for the specific percent below the generated live dealer price. The specific percentage added to or removed from the generated live dealer price, may be changeable by, for example, diamond category, quality, carat, market, and/or other characteristic.

The inventory management system 100, may allow the retailer/dealer to potentially source many of its diamond inventory directly from customers who no longer want their diamonds, or want to trade them in, and thus allow the retailer/dealer 120 to potentially undercut the market retail price. Typically, other jewelers and/or pawn brokers, will buy diamonds from a customer well below what the current diamond is trading for at the given time, for example, many dealers buy diamonds back between 70-60% off of the current trade value (e.g., Rappaport price), and the customer has no idea how much below the current trade value the buy offer is. This may discourage a customer from selling their diamonds because the lack of transparency, and therefore trust, as to whether or not they are getting a fair/descent price. However, using the inventory management system 100, the retailer/dealer would generate the live dealer price, and share the live dealer price with the customer, and offer to pay the customer a price some set percentage below the live dealer price (e.g., 20% percent below), for their diamond. This provides the customer with full transparency as to what their diamond is currently trading for on the wholesale market, in real-time, and the percent below that which the retailer/dealer will pay for the diamond, which would likely be more than what they would have received from other jewelers or pawn brokers. The retailer/dealer may offer to buy any/all diamonds at a specific percent below the then current dealer market price (live dealer price) even diamonds retailer/dealer may not need or did not sell. Thus, providing customers with a reliable, transparent, and predictable way to sell their unwanted diamonds.

For the diamonds the retailer/dealer wants to keep in their inventory, using the inventory management system 100, the retailer/dealer may then turn around and sell the same diamonds for, a certain percent above the live dealer price (e.g., 20%). Therefore, using the inventory management system 100, the retailer/dealer may realize, in this example, a 40% profit margin on the diamond. That is, the retailer/dealer bought the diamond from a customer at 20% below the live dealer price, and then later sold it to another customer at 20% above the live dealer price. In both instance the customer was provided the current live dealer price and was made aware of the 20% markdown/markup, thereby providing complete transparency to the customer.

For diamonds that the retailer/dealer may not want to keep for its own inventory, the retailer/dealer could wholesale them back on one of the gemstone exchange platform, e.g., on the IDEX platform, and since they bought the diamonds below the current dealer market price, the retailer/dealer would likely be able to quickly sell them (e.g., at or below market price) and therefore provide liquidity for cash flow, or other needs.

In either case, i.e., whether buying or selling, the customer has complete transparency in the transaction, and the customer knows the percent markup over current wholesale they will pay when buying a diamond and the percent markdown they will receive when selling a diamond to a retailer/dealer that is using the inventory management system 100. The customer is not left wondering if they paid way too much over current trade value or received an amount way below current trade value.

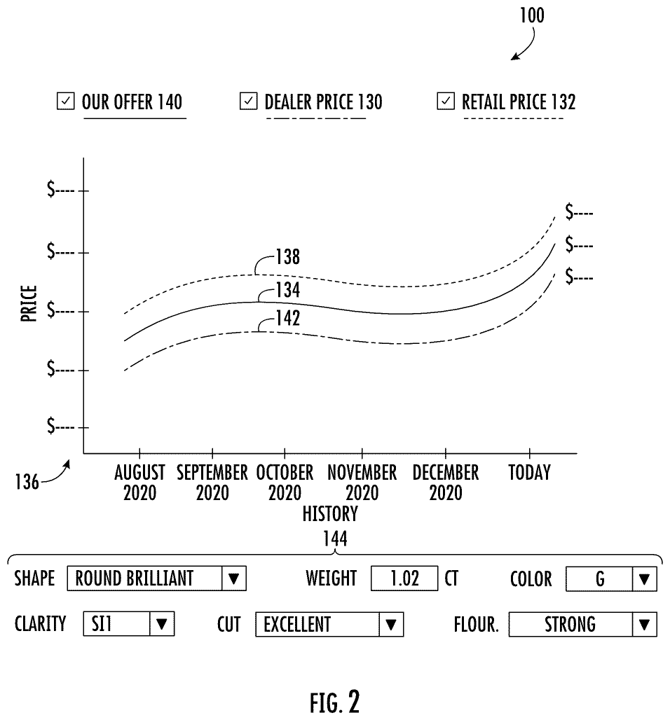

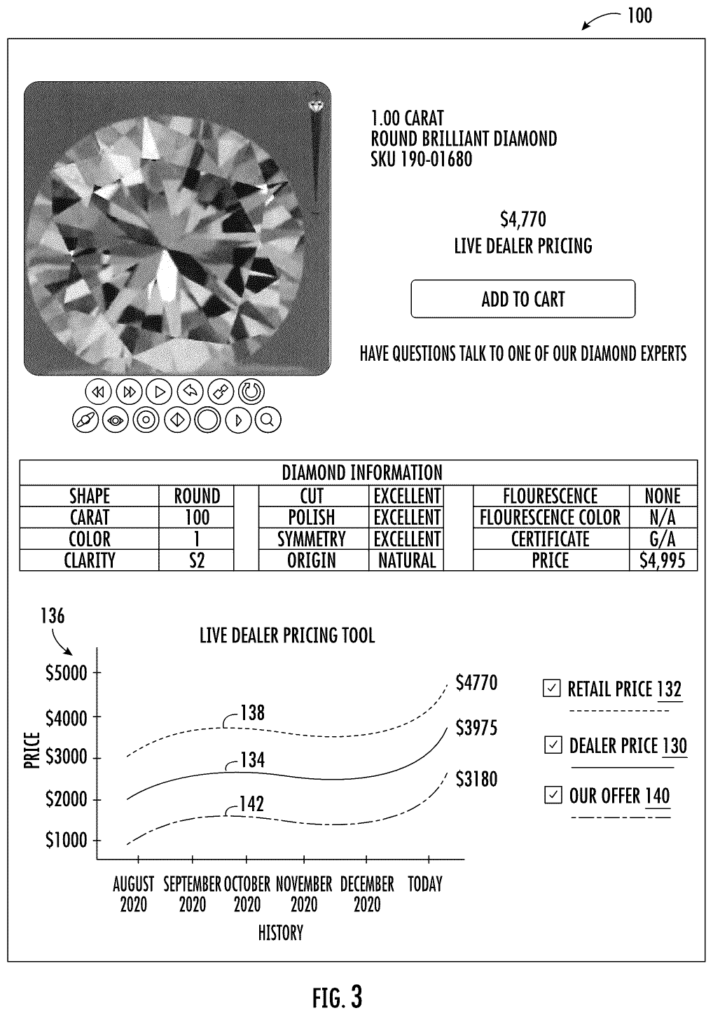

With reference to FIGS. 1-3, in operation, a customer may access a diamond retailer/dealer either at a physical store or electronically online. The customer may identify a diamond of interest from the retailer/dealer's inventory, once the customer has selected a diamond of interest, the retailer/dealer (i.e., user 128) may access the inventory management system 100 via computer 104, and may then select the diamond of interest from its inventory database (e.g., from data store 116). The retailer/dealer may then enter the selected diamond of interest into the live gemstone pricing application 110 and enter the diamond's characteristics (e.g., diamond's cut, color, clarity, carat, fluorescence, lab grade, size, and/or other characteristics). The diamond's characteristics may be automatically entered into the live gemstone pricing application 110 when selecting the diamond of interest from the retailer/dealer's inventory database, or alternatively the retailer/dealer's may manually enter in the diamond's information. The live gemstone pricing application 110 of the inventory management system 100, using communications interface 118, may then query the inventory of one or more of data sources 108 via network 106. In one example, live gemstone pricing application 110, in real-time, may query the wholesale inventory of, for example, the IDEX, for all available diamonds having the same characteristics as the diamond of interest. The live gemstone pricing algorithm 120 of the live gemstone pricing application 110 then calculates the average dealer price based on the dealer pricing information for all the retrieved diamonds, and returns an average live dealer price for the diamond of interest, i.e., average live dealer price 130. In one example, the live gemstone pricing application 110 may additionally provide an average price history, showing the average dealer price of such a diamond over a defined period of time, for example the prior 6 months (as shown for example by line 134 in FIGS. 2 and 3).

The live gemstone pricing application 110, using live gemstone pricing algorithm 120, may, based on the calculated average live dealer price 130, automatically calculate a retail price 132. The calculated retail price 132 may be displayed along with the live dealer price 130, for example, on a display of the computer 104 or some other display, for the customer to view. To calculate the retail price 132, the live gemstone pricing application 110, via the live gemstone pricing algorithm 120, may add a specific percent markup to the calculated average live dealer price 130 and then calculate the retail price 132 by applying the percent markup to the calculated average live dealer price 130. This calculated retail price 132 is the price that the retailer/dealer would sell the diamond to the customer for. In one non-limiting example, the percent markup may be set to 20% above the calculated average live dealer price 130, so in an example where the average live dealer price 130 of the diamond of interest is, for example, $3,975, the retail price 132 would be calculated as $4,770 by the live gemstone pricing application 110. In this example, the customer would be able to view both the current calculated average live dealer price 130 of the diamond of interest along with the calculated retail price 132, thereby, providing the customer with a completely transparent experience. This may also be shown as a historical chart, e.g., chart 136, showing the average live dealer price 130 and retail price 132 going back over some period of time (as shown for example by lines 134 and 138, respectively, in FIGS. 2 and 3), and may be viewable to the customer in the form of a chart, graph, spreadsheet, or any other suitable form, and may be viewable via a display of computer 104, other display, printout, or other mechanism or form.

The live gemstone pricing application 110 may further automatically calculate a buy price 140 and display it along with the calculated average live dealer price 130. For the buy price 140, the live gemstone pricing application 110, via live gemstone pricing algorithm 120, may reduce the calculated average live dealer price 130 by a specific percent markdown and automatically calculate the buy price 140. The buy price 140 is the price that the retailer/dealer would buy a diamond from a customer for. In one non-limiting example, the percent markdown may be set to 20% below the calculated average live dealer price 130, so in an example where the average live dealer price 130 of the diamond of interest is, for example, $3,975, the buy price 140 would be calculated as $3,180 by the live gemstone pricing application 110. In this example, the customer would be able to view both the calculated current average live dealer price 130 of the diamond along with the calculated buy price 140, thereby, providing the customer with a completely transparent experience. This may also be shown as a historical chart, e.g., chart 136, showing the average live dealer price 130 and buy price 140 going back over some period of time (as shown for example by lines 134 and 142, respectively, in FIGS. 2 and 3), and may be viewable to the customer in the form of a chart, graph, spreadsheet, or any other suitable form, and may be viewable via a display of computer 104, other display, printout, or other mechanism or form.

In one example, the customer would be able to view the calculated current average live dealer price 130 of the diamond along with the calculated retail price 132 and the calculated buy price 140. In this example, the customer knows what the current average dealer price 130 is, the retail purchase price 132, as well as the price the retailer/dealer would by the diamond back for, the buy price 140, thereby, the percent markup for retail purchase and percent markdown for buy back is completely transparent to the customer. This may also be shown as a historical chart, e.g., chart 136, showing the average live dealer price 130, retail price 132, buy price 140 going back over some period of time (as shown for example by lines 134, 138, and 142, respectively, in FIGS. 2 and 3), and may be viewable to the customer in the form of a chart, graph, spreadsheet, or any other suitable form, and may be viewable via a display of computer 104, other display, printout, or other mechanism or form.

In one example, inventory management system 100, may further display the diamond information 144 of the selected diamond of interest, for example, but not limited to, the diamond's cut, color, clarity, carat, fluorescence, lab grade, size, photograph and/or other information along with the average live dealer price 130, retail price 132, and/or buy price 140, and/or historical chart/graph.

This kind of transparency allows a customer to understand exactly what they are paying, what their diamond is worth, and what they potentially they would get should they decide to sell their diamond (or trade it in) back to the retailer/dealer. This builds a tremendous amount of trust and customer loyalty, because the customer has all the information and does not have to worry if they are getting a fair deal or not, i.e., not being charged 100%+ markups or taking significant losses on their diamonds when selling back to a jeweler of pawn broker. Every time they buy or sell a diamond they know the current wholesale (dealer price) and the exact markup or markdown that will be applied.

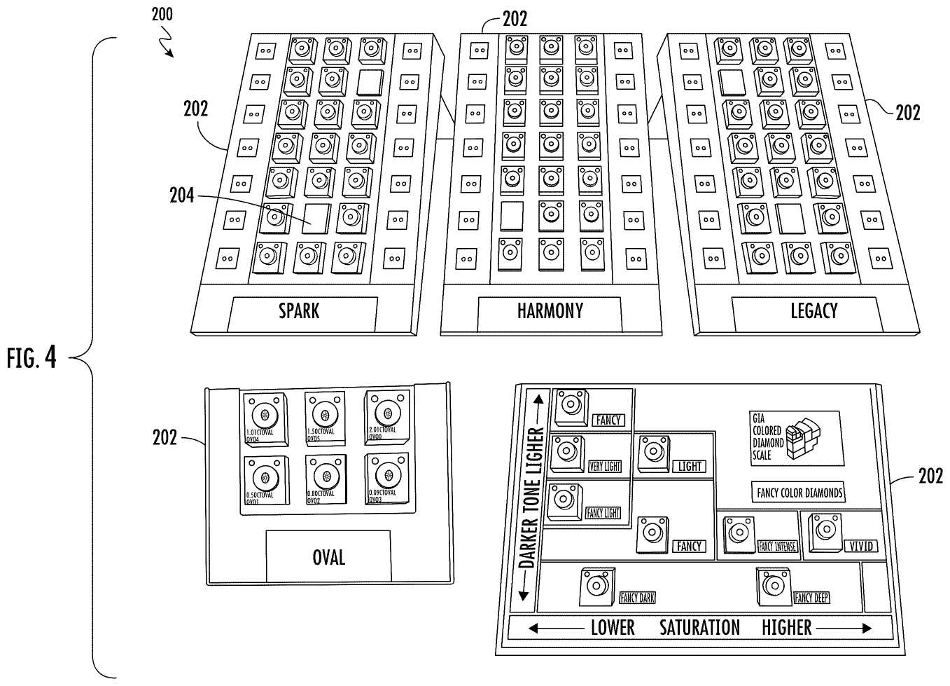

In another embodiment, and referring to FIGS. 4-11, the invention may provide a smart grid display system 200. The way gemstones, such as diamonds, are displayed/presented to a customer in an in-store environment can dramatically affect the customer experience and thereby increase sales. In the smart grid display system 200, loose gemstones, such as diamonds, for example, are laid out in a grid like pattern in a smart grid display 202. By laying out the loose diamonds in a grid like pattern in the smart grid display 202, the smart grid display system 200, creates an unparalleled transparent customer experience when shopping for a diamond. While customers shop, the smart grid display system 200 will learn the customers' preferences, along with sales and customer traffic (showing of the diamond) data using, in one embodiment, artificial intelligence (AI), and may automatically make recommendations to the retailer/dealer of the best diamonds to stock/restock and the best price levels to retail them at. The smart grid display system 200 makes it easy for sales associates, inventory buyers, and, most importantly, customers of the retailer/dealer to make good informed decisions when buying or selling diamonds.

The smart grid display system 200 works by taking much of the guess work out of diamond inventory levels. Depending on the market size and demographics, the smart grid display system 200 to be used, may be slightly different in each market. However, the basic concept is essentially the same.

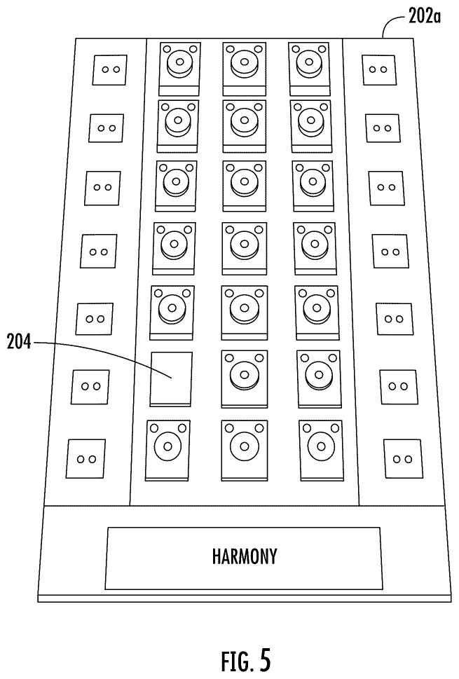

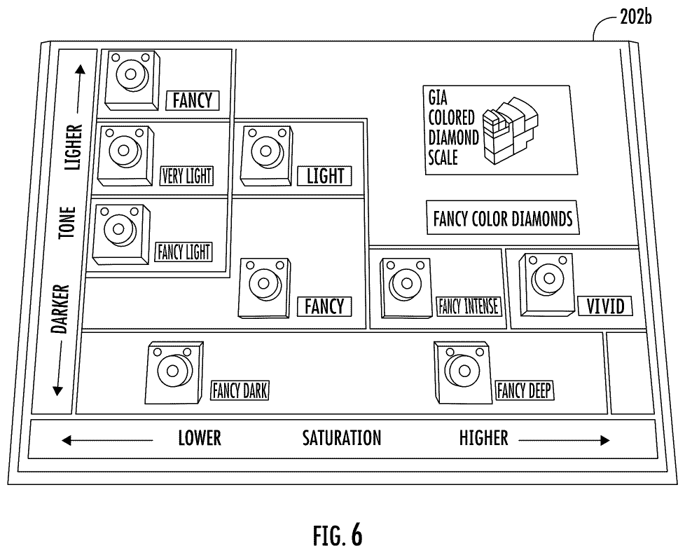

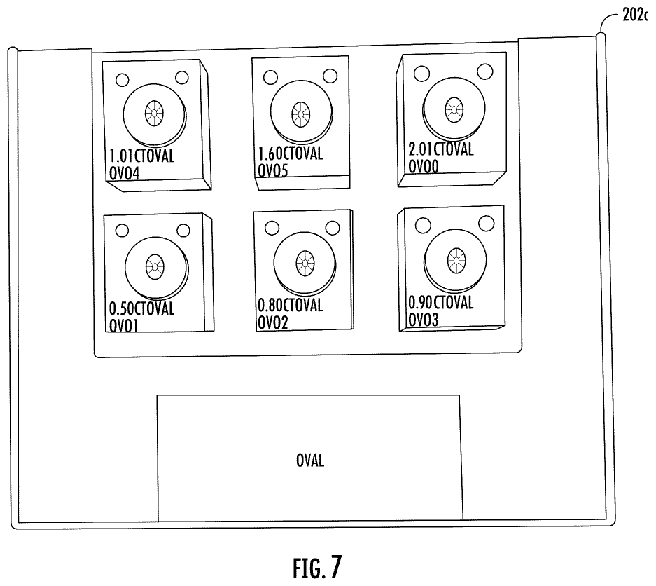

Smart grid display system 200 may include one or more smart grid displays 202 for display in a retail store (as shown for example in FIG. 4), or alternatively in an online retail environment. Each category of diamond may have its own specific smart grid display 202 that may be set up in the store (or online). This allows for a customer to easily view and compare diamonds in the same category by size and level of quality in a systematic and organized way. FIG. 5 shows an example smart grid display 202a including a category of middle quality round shaped diamonds, for example. FIG. 6 shows an example smart grid display 202b including a category of fancy color diamonds (light, intense, dark, vivid, etc.), for example. FIG. 7 shows an example smart grid display 202c may include a category of oval shaped diamonds, for example. These diamond categories are examples only, and smart grid display system 200 may include smart grid displays 202 for any number of differing diamond categories.

The diamond category smart grid displays 202, of the smart grid display system 200, may each include a grid-like layout with a number of individual slots 204 arranged in columns and rows. The individual slots 204 may each receive a single loose diamond for display therein. Each of slots 204 may be assigned a position/tracking code 206 and the diamond in each of the slots 204 may be linked to their particular slot 204 and tracked. Each diamond in slots 204 may also be assigned a position/tracking code 206, which may be the same as the position/tracking code 206 assigned to the slot 204 it resides in, or it may be some other position/tracking code 206, provided it links the diamond with the slot 204 it is in. Therefore, the position/tracking code 206 links a particular diamond to a particular slot 204 of the smart grid display 202.

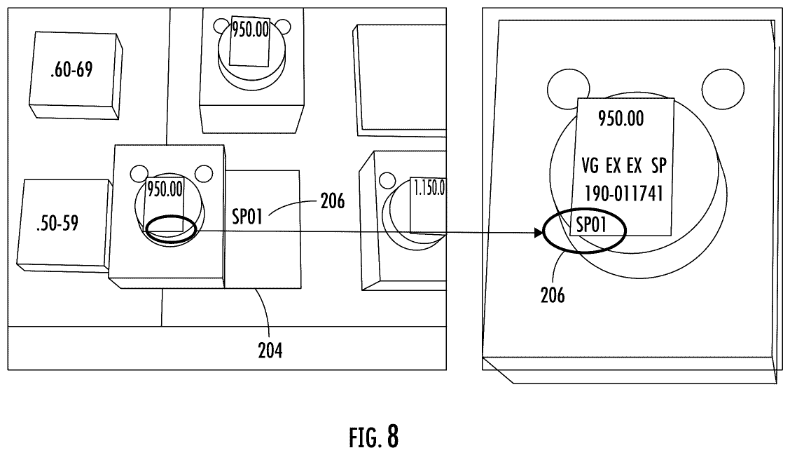

Referring to FIG. 8, in one non-limiting example, a diamond is in a slot 204 of a smart grid display 202, and the slot 204 may be assigned a position/tracking code 206 of, for example, “SP01”. In this example, the diamond may also be assigned or labeled with the same position/tracking code 206, i.e., “SP01”, as that of the slot 204 in which the diamond is positioned in, such that the slot 204, and the diamond in it, each have the same position/tracking code 206, i.e., “SP01”. The position/tracking code 206 for each slot 204 and its associated diamond may be created using any number of techniques. In one non-limiting example, the position/tracking code 206 may be created by using, for example, the first two letters of the category of diamond and then adding a number that represents the slot 204 position on the smart grid display 202. For example, a tracking code of “SP01” may mean “SP”=Spark (retailer/dealer's designated category for a starting price point round diamonds), and “01” may mean the first position on the smart grid display 202 going from bottom left to top right. In this example, by looking at the position/tracking code 206 of either the diamond or its slot 204, the retailer/dealer would know the category of diamond and exactly where in the smart grid display 202 it came from. Position/tracking code 206 may take any suitable form, such as but not limited to, alphanumeric, barcode, QR code, RFID, and/or the like.

In one example, when a diamond is placed in a slot 204, the position/tracking code 206 of the slot 204 and its associated diamond may be entered/recorded into the smart grid display system 200. Along with the position/tracking code 206, details/characteristics associated with the diamond placed therein (e.g., size, quality, pricing, photograph, location in store, source, when entered, and/or other like data), are entered. When the retailer/dealer enters the position/tracking code 206 of the particular slot 204 into the smart grid application 208, the retailer/dealer will be able to retrieve and view all the details of the diamond associated with that particular slot 204 from which the diamond was retrieved. Alternatively, if the retailer/dealer sees an empty slot 204, the retailer/dealer may enter the particular position/tracking code 206, into the smart grid application 208, and the retailer/dealer will be able to see all the details for the diamond that was previously in that slot 204. In one example, the retailer/dealer may access and/or enter information into the smart grid application 208 of the smart grid display system 200 via a smart grid graphical user interface (GUI) 210, which may be running on the inventory management system 100.

The position of each diamond on the smart grid display 202 may correlate to the size, quality, and cost of the diamond. In one example, as you move up slots 204 on the smart grid display 202 the diamond size may get larger, and as you move from left to right of the slots 204 on the smart grid display 202 the quality of the diamond may increase, and therefor as you go from bottom left to top right of the smart grid display 202 the cost of the diamonds therein increase.

The design of the smart grid display 202 this way results in a diamond inventory created to have the biggest selection of category, price, quality, and size with the least amount of inventory. In one example, the smart grid display 202 may not include duplicates of any single diamond.

The smart grid display system 200 allows customers to visually compare several options in one display in a systematic and organized way, which helps the customer to pick the best diamond for them. Additionally, the smart grid display system 200 allows sales associates for the retailer/dealer to easily see the full available diamond inventory, and therefore work with customers to assist them in finding the right diamond for them without having to “go in the back” to check inventory, and also allows buyers for the retailer/dealer to quickly and easily see what may need to be replaced just by glancing at the smart grid display 202, i.e., by identifying slots 204 that are empty.

The smart grid display system 200 may be linked with or instantiated in the inventory management system 100, via for example smart grid application 208 that may be running on server 102. In one example, the retailer/dealer may interact with the smart grid application 208 via the smart grid graphical user interface (GUI) 210. Having smart grid display system 200 linked with the inventory management system 100 enables the retailer/dealer to leverage the data associated with the diamonds, which may include, but is not limited to, the diamond's quality attributes (cut, color, clarity, carat, fluorescence, lab grade, measurements), source, location in store, retail price, cost, margin, number of times shown, number of days in stock, days to sell, number of diamonds in that position sold, and/or other like data. Smart grid application 208 may run on the inventory management system 100 in a similar fashion as that of live gemstone pricing application 110, with respect, for example, to server 102, computer 104, network 106, data sources 108, controller 112, memory 114, data store 116, communications interface 118, authentication module 124, and/or security module 126.

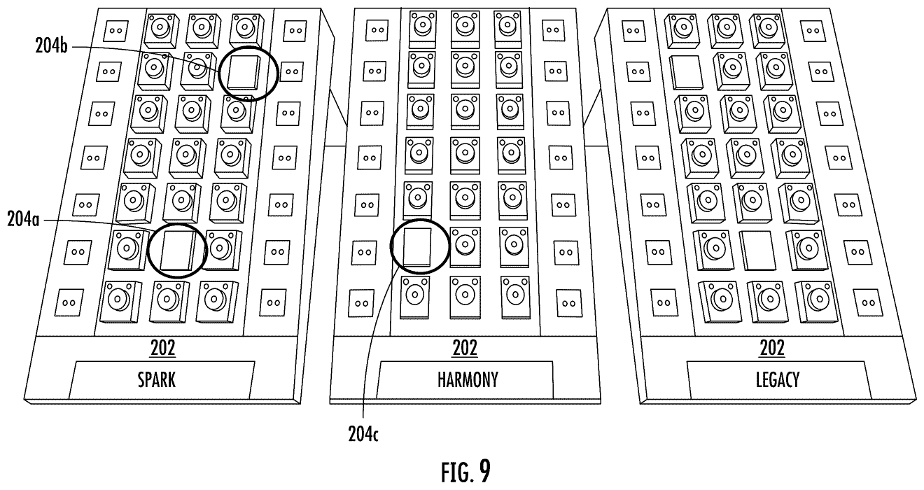

With reference to FIG. 9, in this example, smart grid display 202 has three (3) open slots 204 (204a, 204b, 204c) that are empty, and therefore available to be replaced. Using the smart grid display system 200 linked with the inventory management system 100, the retailer/dealer can quickly pull up the data associated with the open slots 204, i.e., information on the diamonds that were previously in the open slots 204 (204a, 204b, 204c). Based on the retrieved data the retailer/dealer can make an informed decision as to whether or not to replace with the same diamond, different diamond, or other decision.

In one example, each time a diamond is retrieved from a particular slot 204 of the smart grid display 202, to be shown and/or sold, the retailer/dealer enters (or scans) the associated position/tracking code 206 of the slot 204 (and/or diamond) from which the diamond was removed into the smart grid application 208 of the inventory management system 100. Therefore, as the retailer/dealer enters the position/tracking code 206 of a slot 204, the retailer/dealer can see along with the particular characteristics (cut, color, clarity, carat, fluorescence, lab grade, measurements) of the diamond in the particular slot 204, the retailer/dealer may also see other associated data, such as, retail price, cost, margin, number of times shown, number of days in stock, days to sell, number of diamonds in that position sold, and/or other like data. Using this data the retailer/dealer can, for example, make better informed decisions regarding stocking and/or restocking of inventory. For example, if the retailer/dealer sees an open slot 204 in a display 202, the retailer/dealer can enter the position/tracking code 206 of the open slot 204 and see, in one example, the number of times shown, number of days in stock, number of days to sell, number of diamonds in that position sold and/or other like data. If, for example, diamonds in that slot 204 have been shown frequently and several have sold with minimal time in that position, then the retailer/dealer may want to make sure and reorder that diamond. On the other hand, if diamonds in that slot 204 have not sold frequently, spent several days in that position, not shown very frequently, and/or were shown but with few sales then the retailer/dealer may decide that is not a diamond to keep in stock (or to understock it). Additionally, the smart grid application 208 of the inventory management system 100 may use this historical information to automatically make inventory stocking/restocking recommendations to the retailer/dealer, by, for example, making recommendations as to which diamonds to stock/restock and the best price levels to retail them. Also, by being connected to one or more data sources 108, e.g., the IDEX, the retailer/dealer can compare their diamond data with data of diamonds (e.g., 1 million diamonds+) that are currently on the wholesale market, e.g., on the IDEX platform, and using the system's artificial intelligence, may, for example, do any one or more of the following, amongst other things:
1. Make recommendations of the best diamonds to buy listed on the wholesale market platform to replace diamonds that have sold, i.e., to replace open slots 204 in the smart grid display 202.
2. Determine what diamonds to have understock of and how many, which will optimize turn and profitability.
3. Understand the category requirements for each smart grid display 202 and automatically generate a smart grid of existing owned loose diamond inventory to populate the smart grid display 202. This can also be done with diamonds from memo suppliers (i.e., supplier that provides the product on consignment and retailer pays them once it has sold), the retailer/dealer may create virtual boards online that the retailer/dealer can sell from and bring in diamonds to view.
4. Reduce aged and excess inventory. When over stocked in a diamond, or when on hand for too long, the system may automatically post it for sale on one of the wholesale market platforms, e.g., the IDEX, to wholesale the diamond to make room for a diamond that will sell faster based on historical sales data collected by the smart grid application 208 of the smart grid display system 200. In one example, the retailer/dealer may create certain rules within the system, such that when the inventory level of a diamond reaches a pre-determined amount, or has been on hand for a pre-determined amount of time (e.g., days), the system automatically posts it for sale on the wholesale market, e.g., the IDEX platform. The system may automatically send an alert to the retailer/dealer that a particular diamond is, or is about to be listed for sale on the IDEX based on the set rules. The system may also automatically send an alert once the diamond is sold, and may automatically update the inventory accordingly.

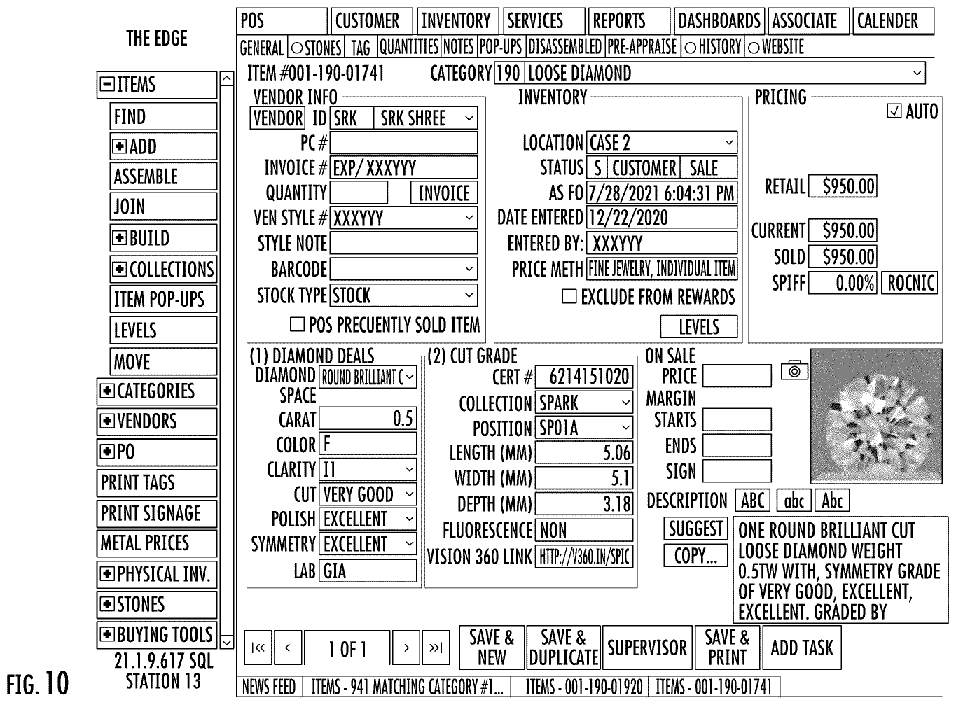

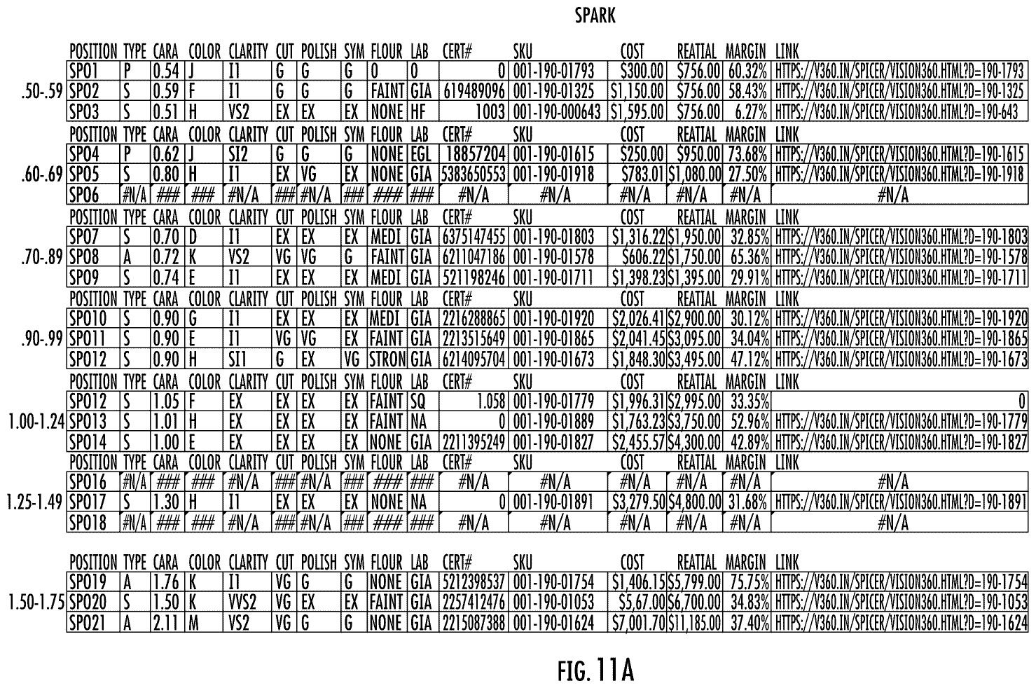

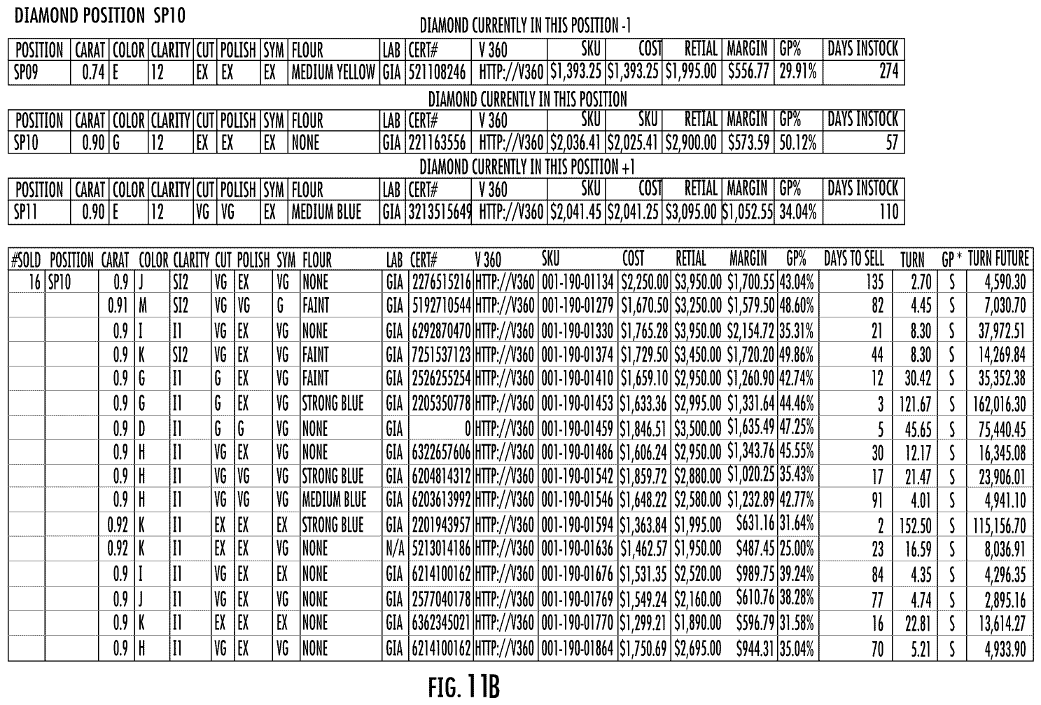

FIG. 10 shows an example screenshot from an example smart grid GUI 210 showing example information entered for a particular diamond in the retailer/dealer's inventory. FIGS. 11a and 11B show screenshots of an example database including example types of information captured for a particular category of diamonds in the retailer/dealer's inventory.

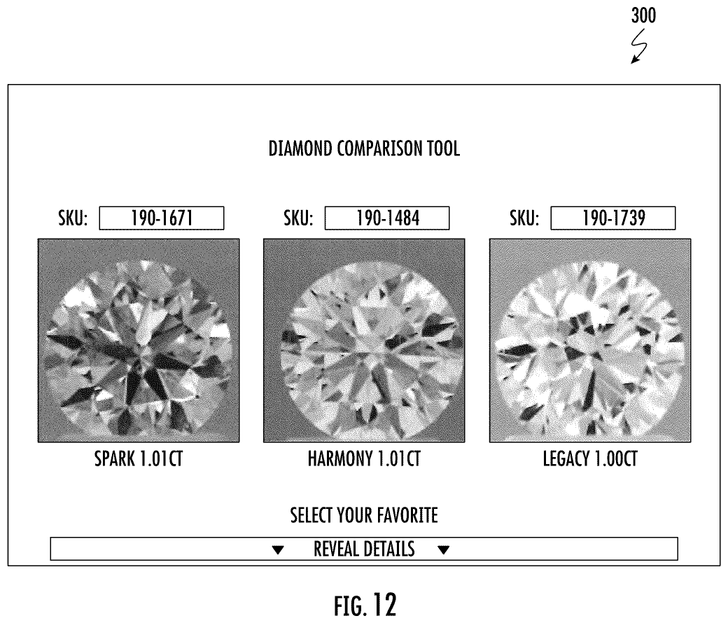

In another embodiment, and with reference to FIGS. 12-14, the invention may provide a diamond comparison tool 300. Diamond comparison tool 300, may include a diamond comparison tool application 302, and may be running on or linked with the inventory management system 100. Diamond comparison tool application 302 may run on the inventory management system 100 in a similar fashion as that of live gemstone pricing application 110 and/or smart grid application 208, with respect, for example, to server 102, computer 104, network 106, data sources 108, controller 112, memory 114, data store 116, communications interface 118, authentication module 124, and/or security module 126.

Diamond comparison tool 300 allows for a customer 301 to easily compare multiple diamonds side by side. In one example, retailer/dealer 303 may bring a customer a certain number of diamonds (e.g., three) for the customer 301 to physically view. The retailer/dealer 303 may enter/scan each of the diamond's SKUs or other identifier (e.g., position/tracking code 206), into the diamond comparison tool application 302 of the diamond comparison tool 300. The diamond comparison tool 300 may be accessible via a computer 104, for example on a tablet positioned at an area of the store where the diamonds are being shown to the customer 301 (e.g., the “Diamond Bar”). As the diamonds' SKUs or other identifier are entered/scanned into the diamond comparison tool 300, via, for example, a diamond comparison tool graphical User Interface (GUI) 304, the diamonds are displayed, for example, on one or more screens. In one example, each diamond may be displayed on its own screen or on the same screen. In another example, the diamonds may be displayed on the computer 104, for example the display of a tablet, or on a separate display from computer 104. As the retailer/dealer 303 enters/scans the diamonds being shown to the customer 301, the system stores this information, e.g., how many times a diamond is shown, when a diamond is shown, etc.

In one example the retailer/dealer 303 may purposely select a good, a better, and a best quality diamond in the same carat range and the same shape to show the customer 301. The carat range is typically based on an initial conversation with the customer 301 on what their budget is. As an example, if the customer 301 is clearly on a budget the retailer/dealer 303 may use 0.50 ct as a starting point, if the customer 301 indicates they want a large diamond the retailer/dealer 303 may use 2.00 ct as a starting point, and if customer 301 is unsure then the retailer/dealer 303 may use 1.00 ct as a starting point. An example screenshot of the presented diamonds displayed on a screen is shown, for example in FIG. 12, which shows the presented diamonds side by side, and may also display some limited information, such as, but not limited, the diamonds' SKUs, ct size, category.

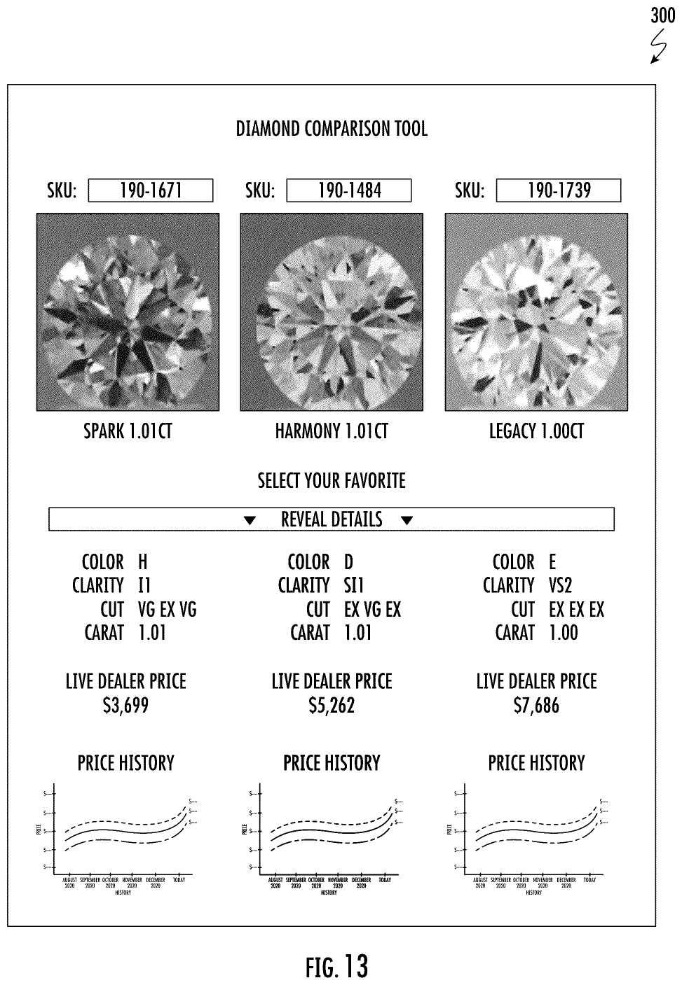

Once the customer 301 has selected their favorite diamond of the diamonds presented to them, the retailer/dealer 303 (or customer 301), using the diamond comparison tool GUI 304 of the diamond comparison tool 300 may select “reveal details” to reveal additional details of the diamonds, e.g., quality (cut, color, clarity, carat). In addition to the quality details, the full pricing details of the diamond (as generated, for example, by the live gemstone pricing application 110) may be displayed to the customer 301 with full transparency on retail price 132, dealer price 130, and buy back price 140. An example screenshot of the presented diamonds displayed on a screen with the details reveled is shown, for example in FIG. 13, which shows the presented diamonds side by side, and may also display additional details of the diamonds, such as, but not limited, the quality (cut, color, clarity, carat) and full pricing details of the diamonds.

The customer 301 can now make an informed decision to decide if they see enough difference in the diamond they picked compared to the others based on the way it looks in real life that equals the amount of difference in price. That is, looking at the diamonds in real life, does the customer 301 see an amount of difference between the diamond they picked compared to the others that equals the price difference.

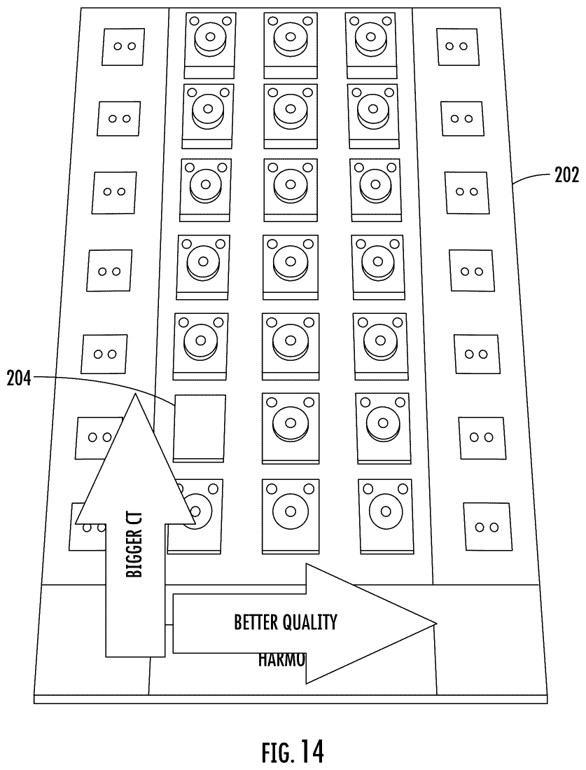

At this point the retailer/dealer 303, with the customer's 301 feedback on those diamonds, may then use the smart grid display system 200 to show the customer 301 more diamonds in their interest area. Using the smart grid display system 200, by taking the customer 301 horizontally left to right on the smart grid display 202, the diamonds get better quality and more expensive, and by taking the customer 301 vertically bottom to top on the smart grid display 202, the diamonds get bigger and more expensive (as shown for example in FIG. 14). This makes it easy for both the customer 301 and the retailer/dealer 303 to systematically and effectively compare different price points, sizes, and qualities of diamonds until the customer 301 finds a diamond, they love within the budget they had in mind. This systematic and organized approach allows the customer 301 to sort through the many options that may be available and to select that perfect diamond for them, and does so with complete pricing transparency.

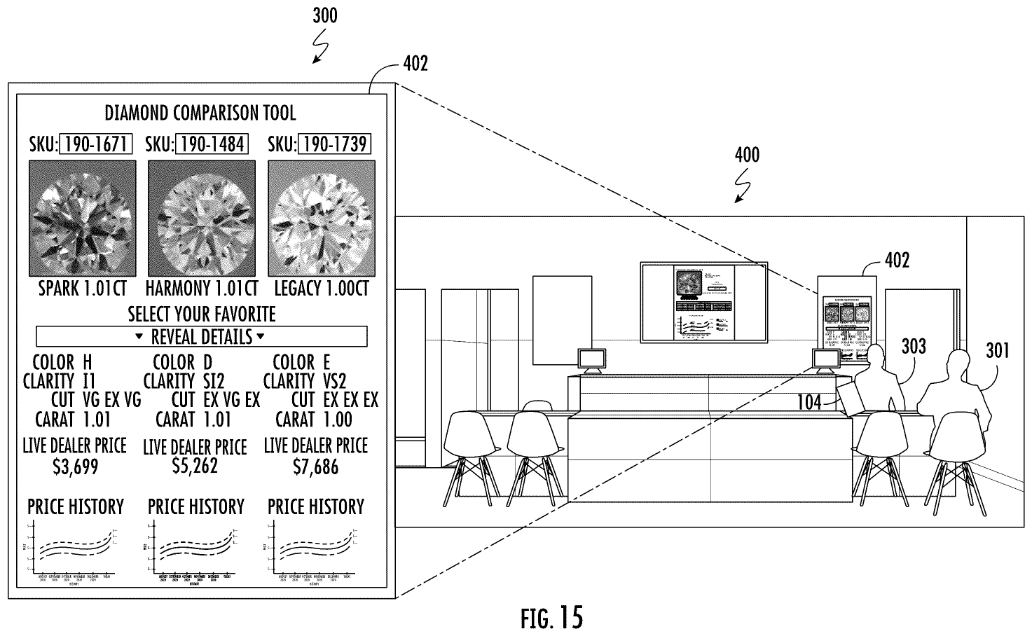

With reference to FIG. 15, in one example, the retailer/dealer 303 may use the diamond comparison tool 300 in an in-store environment to set-up a “diamond bar” 400 where customers 301 can come to see/sample diamonds “diamond tasting”. In this example, the diamond comparison tool 300 may be accessed via a computer 104, such as a tablet 104, positioned in the retailer/dealer's store, for example as part of the store as the “diamond bar”, specifically set up for “diamond tasting.” As detailed in the preceding paragraphs, a customer 301 may be presented with a selected sample of actual diamonds to physically look at (taste), as the diamonds are presented to the customer 301 they may be entered/scanned into the diamond comparison tool application 302 and displayed to the customer 301 on one or more displays 402. For example, the diamonds may be displayed on one or more display screens 402 that may be separate from the tablet 104, but is positioned such that it is easily viewable by the customer 301. Alternatively, the diamonds may be displayed on the display of the computer/tablet 104.

This unique “diamond bar” and “diamond tasting” provides a revolutionary new transparent way to buy, sell, or upgrade a diamond or piece of jewelry, and provides a completely transparent, fun, and easy experience for a retailer/dealer's customers when buying, selling, or upgrading a diamond or a diamond piece of jewelry. Like a wine tasting at a wine bar, this unique diamond bar retail experience puts a vast selection of diamonds in front of the customer allowing them to compare a large selection of diamonds, and based on the diamond's real life physical beauty, find the one perfect for them.

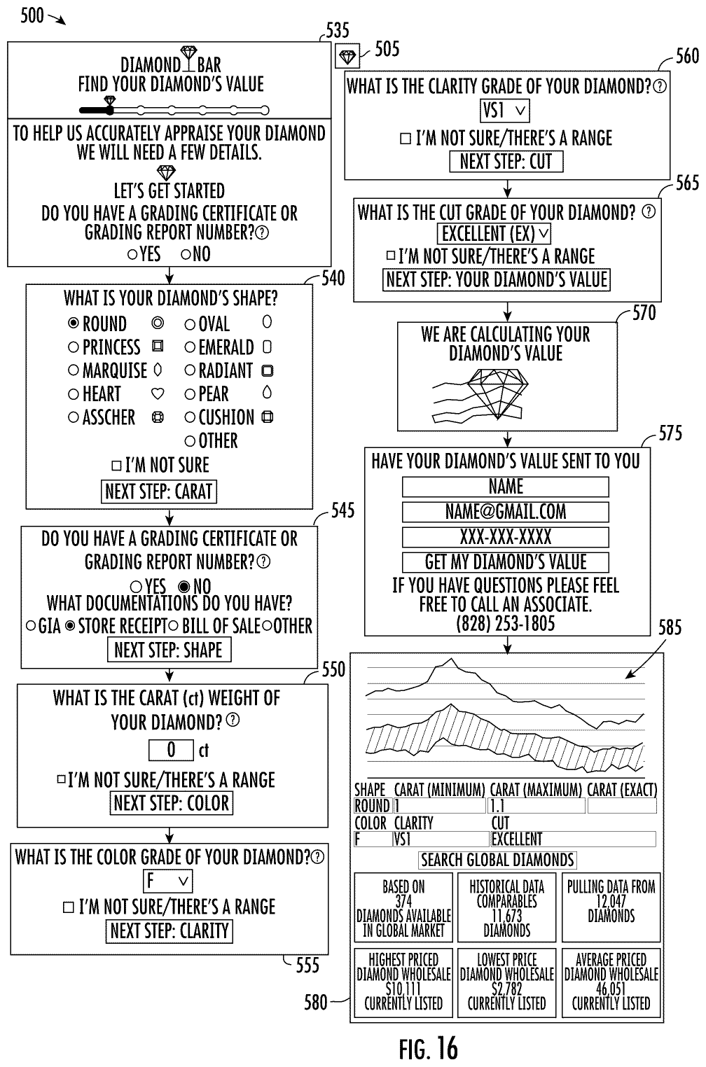

In another embodiment, and with reference to at least FIGS. 1-3, 16, and 17, the invention may provide a live customer gemstone appraisal system 500. The live customer gemstone appraisal system 500 may include the live gemstone pricing application 110, which may produce a customer gemstone price report 585, in real-time, based on entered gemstone attribute data of a customer's gemstone (customer gemstone 505) together with data from one or more data sources 108. In live customer gemstone appraisal system 500, the live gemstone pricing application 110 and live pricing algorithm 120 operate in much the same way as described above, with regard to inventory management system 100, to process and calculate pricing information of the customer gemstone price report 585. In one example, live customer gemstone appraisal system 500 may be accessed by a customer 128 via live customer pricing GUI 522 on, for example, their personal device 104 via the network 106. Live customer pricing GUI 522 may include a number of interactive screens, as shown for example in screenshots 535-580 of FIG. 16, through which customer 128 may enter gemstone attribute data for a particular customer gemstone 505. As shown for example in FIG. 16 screenshots 535-565, live customer pricing GUI 522 may prompt customer 128 to enter attribute data related to the customer gemstone 505, which may include, but is not limited to, one or more of gemstone grading report or certificate number, shape, weight, color grade, clarity grade, cut grade, and/or any other attribute data of customer gemstone 505. In one example, live customer pricing GUI 522 may additionally or alternatively prompt customer 128 to upload documents and/or files associated with the particular customer gemstone 505, such as a grading certificate, grading report, receipt, appraisal report and/or other such documents. Once all the attribute date is entered, live gemstone pricing application 110 may generate a gemstone price report 585. The a gemstone price report 585 may be displayed to customer 128 through the live customer pricing GUI 522, as shown in example screenshot 580. Live gemstone pricing application 110, through live gemstone pricing algorithm 120, may use the entered gemstone attribute data, along with data from one or more data sources 108, to produce the live customer gemstone price report 585. The customer gemstone price report 585 may be displayed to the customer 128 via the live customer pricing GUI 522, and may include current and/or historical pricing information for comparable gemstones, for example in the form of a graph/chart, and may include pricing information, such as, but not limited to, dealer/wholesale price(s), retail price(s), and/or the number of comparable gemstones currently available in the global market. The pricing information may be shown as an average, high/median/low, and/or other manner. The customer gemstone price report 585 may further include a buy price, which may be the price the retailer/dealer would be willing to pay the customer for the customer gemstone 505. In one example, the buy price may be a specific percent reduction from the calculated average dealer/wholesale price. The customer gemstone price report 585 may further include information regarding the gemstone data pool from which the pricing information was based on, e.g., number of gemstones currently available, number of gemstones the data was based on, and/or other like information. Further, the live customer pricing GUI 522 may prompt the customer 128 to enter their contact information, as shown for example in screenshot 575, to which the customer gemstone price report 585 and/or other information may be sent or shared. The live customer gemstone appraisal system 500 may store the customer's entered contact information, along with the entered customer gemstone 505 attribute data, for example in data store 116. In this example, the live customer gemstone appraisal system 500 may provide dealers with access to the stored contact information and gemstone attributes allowing dealers to contact customers 128 who may be interested in selling their gemstone 505. The live customer gemstone appraisal system 500 improves transparency for customers 128 seeking to sell their gemstones by providing accurate pricing information for comparable gemstones on the market in the form of a live gemstone pricing report 585. Additionally, the live customer gemstone appraisal system 500 provides value to dealers by storing the entered contact information and gemstone attributes of customers 128 who used the live customer gemstone appraisal system 500. The live gemstone appraisal system 500 may expand access to inventory for dealers, while providing customers 128 with transparent information regarding the value of a given customer gemstone 505.

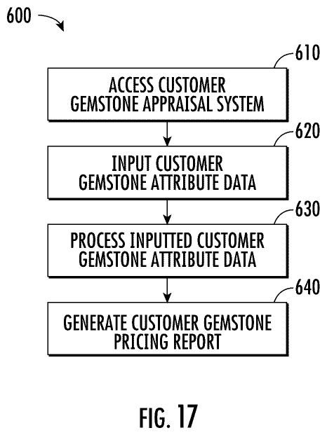

FIG. 17 is a flow diagram of an example of a method 600 of using live customer gemstone appraisal system 500, in accordance with an embodiment of the invention.

Method 600 may include, but is not limited to, the following steps and/or order of steps. At a step 610, a live customer gemstone appraisal system is accessed by a customer. For example, live customer gemstone appraisal system 500 may include a live pricing application 110, live pricing algorithm 120, and live customer pricing GUI 522 as described hereinabove with reference to FIG. 1 through FIG. 17. A customer 128 may access the live customer gemstone appraisal system 500 via live customer pricing GUI 522.

At a step 620, the customer enters gemstone attribute data of their gemstone. For example, live customer pricing GUI 522 may be used to collect information from the customer 128, prompting the customer 128 to enter certain attribute data of the customer gemstone 505 into the live customer pricing GUI 522, as shown for example in FIG. 16 screenshots 535-565.

At a step 630, the entered customer gemstone attribute data is processed in real time. For example, the live gemstone pricing application 110 of live customer gemstone appraisal system 500, using the live pricing algorithm 120, processes the entered customer gemstone attribute data together with information from one or more data sources 108 to generate real-time pricing information.

At a step 640, a gemstone price report is generated and delivered and/or displayed to the customer. For example, the live gemstone pricing application 110 of live customer gemstone appraisal system 500 generates the customer gemstone price report 585, which may be displayed to the customer 128 via the live customer pricing GUI 522. The customer gemstone price report 585 may include current and/or historical pricing information for comparable gemstones, for example in the form of a graph/chart, and may include pricing information, such as, but not limited to, dealer/wholesale price(s), retail price(s), and/or the number of comparable gemstones currently available in the global market. The pricing information may be shown as an overall average, high/median/low, and/or other statistical manner. The customer gemstone price report 585 may further include a buy price, which may be the price the retailer/dealer would be willing to pay the customer for the customer gemstone 505. In one example, the buy price may be a specific percent reduction from the calculated average dealer/wholesale price. The customer gemstone price report 585 may further include information regarding the gemstone data pool from which the pricing information was based on, e.g., number of gemstones currently available, number of gemstones the data was based on, and/or other like information.

Prior to or after step 630, the live customer gemstone appraisal system 500 may prompt the customer 128 to enter their contact information, as shown for example in screenshot 575, to which the customer gemstone price report 585 and/or other information may be sent or shared. The gemstone pricing application 110 may store the entered contact information of the customer 128 along with the entered customer gemstone 505 attribute data, in for example data 116. In this example, the live customer gemstone appraisal system 500 may provide dealers with access to the stored contact information of the customer 128 and customer gemstone attribute data allowing dealers to contact customers 128 who may be interested in selling their customer gemstone 505.

The live customer gemstone appraisal system 500 improves transparency for customers 128 seeking to sell their gemstones by providing accurate pricing information for comparable gemstones on the market in the form of a live gemstone pricing report 585. Additionally, the live customer gemstone appraisal system 500 provides value to dealers by storing the entered contact information and gemstone attribute data of customers 128 who used the live customer gemstone appraisal system 500. In this example, the live gemstone appraisal system 500 expands access to inventory for dealers while providing customers 128 with transparent information regarding the market value of a given customer gemstone 505.

In one example, in use, a customer 128 who wants to find out the current value of their gemstone (i.e., gemstone 505), may access a gemstone retailers website through the network 106 via a web browser using computing device 104. Customer 128 may then access the live customer pricing GUI 522 of the live gemstone appraisal system 500 via a link on the gemstone retailers website. At the live customer pricing GUI 522, customer 128 may follow prompts for inputting the attribute data of the customer gemstone 505. The customer gemstone 505 attribute data may include grading certificate number, grading report number, identity of grading lab, gemstone shape, carat weight, color grade, clarity grade, and/or other related gemstone information. Once the requested customer gemstone 505 attribute data is entered, customer 128 may select to calculate the value of customer gemstone 505. The live gemstone pricing application 110 and live pricing algorithm 120 of live gemstone appraisal system 500, may then collect data (e.g., pricing information) for gemstones having similar attributes from data sources 108, analyzes the pricing information for the collected gemstone data (e.g., analysis of historical pricing data), and calculates pricing data (e.g., current value) for the customer gemstone 505 and generates a customer gemstone price report 585, which includes the current value of customer gemstone 505. In one embodiment, prior to receiving the customer gemstone price report 585, the customer 128 may be prompted to enter their contact information, and once entered the customer gemstone price report 585 may be displayed via the live customer pricing GUI 522 and/or sent to the contact information entered by the customer 128. The live customer pricing GUI 522 may provide drop down boxes to provide customer 128 with a list of options to select for entering certain ones of the attribute data for the customer gemstone 505. During entry of the attribute data of the customer gemstone 505, if customer 128 is unsure of or does not have the requested attribute data, the live customer pricing GUI 522 may prompt the customer 128 to schedule an appointment with the gemstone retailer.

Although the above has been described largely in the context of diamonds, it should be understood that the systems and methods of the invention can be applied to all gemstones, and the subject matter of the invention is not limited to diamonds only.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A gemstone appraisal system, comprising:
a. a server, the server including a pricing application, a pricing algorithm, a pricing GUI, controller, operating memory, and a communications interface, wherein the server is accessible via a network;
b. a data store in communication with the server;
c. one or more data sources, wherein the one or more data sources are accessible to the pricing application via the network; and
d, wherein the controller is configured to execute stored program instructions, comprising:
i. providing access to a user;
ii. receiving gemstone data related to a subject gemstone;
iii. querying one or more data sources via the network for pricing information of gemstones having substantially the same characteristics as that of the subject gemstone;
iv. analyzing the query results and calculating in real-time pricing data for the subject gemstone, wherein the pricing data comprises one or more of a historical price data, current dealer/wholesale price data, current retail price data, and/or a buy price for the subject gemstone; and
v. generating a price report for the subject gemstone, wherein the price report comprises the calculated pricing data.

2. The system of claim 1 wherein the one or more data sources comprise one or more gemstone trading platforms comprising real-time dealer/wholesale and/or retail gemstone pricing information.

3. The system of claim 1, wherein the user accesses the pricing application of the gemstone appraisal system through the network via a web browser using a computing device.

4. The system of claim 1, wherein the user accesses the pricing application of the gemstone appraisal system via a local pricing application installed on a computing device.

5. The system of claim 1, wherein the gemstone data comprises gemstone type and associated characteristics of the subject gemstone.

6. The system of claim 5, wherein the pricing GUI prompts the user to enter the gemstone data of the subject gemstone into the pricing application.

7. The system of claim 5, wherein the associated characteristics comprises size and/or quality attribute data.

8. The system of claim 5, wherein the associated characteristics comprise one or more of cut, color, clarity, carat, fluorescence, lab grade, and size.

9. The system of claim 1, wherein calculating the pricing data of the subject gemstone comprises averaging the real-time pricing information for all the gemstones having substantially the same characteristics retrieved from the query of the one or more data sources.

10. The system of claim 1, wherein the subject gemstone comprises a customer gemstone.

11. A method of using a gemstone appraisal system, the method comprising:
a. providing a gemstone appraisal system, the gemstone appraisal system comprising:
i. a server, the server including a pricing application, a pricing algorithm, a pricing GUI, controller, operating memory, and a communications interface, wherein the server is accessible via a network;
ii. a data store in communication with the server;
iii. one or more data sources, wherein the one or more data sources are accessible to the pricing application via the network; and
iv, wherein the controller is configured to execute stored program instructions, comprising:
providing access to a user;
receiving gemstone data related to a subject gemstone;
querying one or more data sources via the network for pricing information of gemstones having substantially the same characteristics as that of the subject gemstone;
analyzing the query results and calculating in real-time pricing data for the subject gemstone, wherein the pricing data comprises one or more of a historical price data, dealer/wholesale price data, retail price data,
and/or a buy price for the subject gemstone; and
generating a price report for the subject gemstone,
wherein the price report comprises the calculated pricing data;
b. accessing the pricing application;
c. entering gemstone attribute data of the subject gemstone;
d. processing the entered gemstone attribute data together with information from the one or more data sources;
e. calculating real-time pricing data for the subject gemstone, wherein the pricing data comprises one or more of a historical price data, current dealer/wholesale price data, current retail price data, and/or a buy price for the subject gemstone; and
f. generating a price report for the subject gemstone, wherein the price report comprises the calculated pricing data.

12. The method of claim 11, wherein the one or more data sources comprise one or more gemstone trading platforms comprising real-time dealer/wholesale and/or retail gemstone pricing information.

13. The method of claim 11, wherein the user accesses the pricing application of the gemstone appraisal system through the network via a web browser using a computing device.

14. The method of claim 11, wherein the user accesses the pricing application of the gemstone appraisal system via a local pricing application installed on a computing device.

15. The method of claim 11, wherein the gemstone data comprises gemstone type and associated characteristics of the subject gemstone.

16. The method of claim 15, wherein the pricing GUI prompts the user to enter the gemstone data of the subject gemstone into the pricing application.

17. The method of claim 15, wherein the associated characteristics comprises size and/or quality attribute data.

18. The method of claim 15, wherein the associated characteristics comprise one or more of cut, color, clarity, carat, fluorescence, lab grade, and size.

19. The method of claim 11, wherein calculating the pricing data of the subject gemstone comprises averaging the real-time pricing information for all the gemstones having substantially the same characteristics retrieved from the query of the one or more data sources.

20. The method of claim 11, wherein the subject gemstone comprises a customer gemstone.
